(19) United States
(12) Patent Application Publication
(10) Pub. No.: US 2024/0109403 A1
(43) Pub. Date: Apr. 4, 2024

(54) VEHICLE ROOF HAVING A SEALING SYSTEM AND A METHOD FOR MANUFACTURING THE SAME

(71) Applicant: Webasto SE, Stockdorf (DE)

(72) Inventors: Harald SOMMER, Weilheim (DE); Waseem ARAFT, Auburn Hills, MI (US); Dominik KERKEL, Stockdorf (DE); Alois MÜLLER, Stockdorf (DE)

(21) Appl. No.: 18/450,686

(22) Filed: Aug. 16, 2023

Related U.S. Application Data
(60) Provisional application No. 63/411,860, filed on Sep. 30, 2022.

(51) Int. Cl. B60J 7/11; B60J 10/00; B60J 10/90

(52) U.S. Cl. CPC B60J 7/11; B60J 10/45; B60J 10/90

(57) ABSTRACT

A vehicle roof includes a base structure and a rigid roof panel which is fastened to the base structure and constitutes a composite component and has at least one edge forming a filling area which is sealed by a sealing system. The sealing system is formed from a sealing mass applied in multiple layers.

### CROSS REFERENCE TO RELATED APPLICATION

This application claims benefit of provisional application No. 63/411,860, filed Sep. 30, 2022, the content of which is incorporated herein in its entirety for all purposes.

### BACKGROUND OF THE INVENTION

The invention relates to a vehicle roof, comprising a base structure and a rigid roof panel which is fastened to the base structure and constitutes a composite component and has at least one edge forming a filling area which is sealed by a sealing system and to a method for manufacturing such a vehicle roof.

From document DE 10 2020 131 219 A1, a vehicle roof is known which comprises a roof panel which is fastened onto a roof substructure or base structure which can be formed from vehicle pillars, longitudinal roof beams, transverse roof beams and/or the like. The roof panel can be detachably or fixedly connected to the base structure and constitutes a composite component which for example has a carrier layer forming a honeycomb structure to which a polyurethane/glass fiber mixture is applied on both sides. Another structural layer can be disposed on the carrier layer, said structural layer being formed as an SMC layer (Sheet Molding Compound layer) and forming a surface of the roof panel which faces the vehicle environment. The composite component has at least one edge which is in particular in contact with the base structure. The edge is mechanically treated. For this reason, the edge is provided with a sealing system which is formed from a sealing lacquer reaching over the treated edge. The sealing lacquer is supposed to prevent gas releases in the area of the edge of the roof panel which can involve a formation of bubbles. The known sealing lacquer, however, does not meet the requirements.

### SUMMARY OF THE INVENTION

The object of the invention is to create a vehicle roof of the type described above with which a reliable sealing of an edge of the roof panel is guaranteed so that there are no undesired gas releases and the like in this area, and to create a method for manufacturing such a vehicle roof.

This object is attained in accordance with the invention by the vehicle roof having a base structure and a rigid roof panel which is fastened to the base structure and constitutes a composite component and has at least one edge forming a filling area which is sealed by a sealing system, characterized in that the sealing system is formed from a sealing mass applied in multiple layers.

The object is also attained in accordance with the invention by a method for manufacturing a roof panel of a vehicle roof, comprising the following steps:
manufacturing a planar composite component which has at least one edge forming a filling area; and
applying a sealing mass onto the filling area, the sealing mass being applied in multiple layers for forming a multi-layer sealing system.

### BRIEF DESCRIPTION OF THE SEVERAL VIEWS OF DRAWINGS

An exemplary embodiment of a vehicle roof according to the invention is illustrated in the drawing in a schematically simplified manner and will be discussed in more detail in the following description.

FIG. 1 shows a vehicle body having a vehicle roof according to the invention; and

FIG. 2 shows a strongly schematized section through an edge area of a roof panel of the vehicle roof according to FIG. 1 along line II-II in FIG. 1.

### DETAILED DESCRIPTION OF THE INVENTION

According to the invention, a vehicle roof is thus proposed which comprises a base structure and a rigid roof panel which is fastened to the base structure and constitutes a composite component and has at least one edge forming a filling area which is sealed by a sealing system. The sealing system is formed from a sealing mass applied in multiple layers.

The sealing system realized in accordance with the invention guarantees that no gases and solvents can be released from the composite component via the edge of the roof panel or composite component. This guarantees a positive surface appearance in the area of the edge of the roof panel. In addition, a good adhesivity can be achieved in the area of the edge without the gas releases so that a paintability of the roof panel can be also guaranteed in the area of the edge or of the filling area.

The multi-layer sealing system comprises at least two sealing mass layers, preferably four to six sealing mass layers. The total thickness of the sealing system preferably amounts to at least 150 μm, which reliably prevents gas releases. In a special embodiment of the vehicle roof according to the invention, the sealing system has a total thickness of 750 μm.

Furthermore, it is advantageous if the sealing mass is all in all emission-free so that it has not shrunk essentially even after a hardening process. In particular, it is free from volatile organic components such as solvents.

In an advantageous embodiment of the vehicle roof according to the invention, the sealing mass of the sealing system is formed from a solvent-free acrylate and/or a solvent-free polyurethane, in particular a solvent-free polyurethane acrylate copolymer, and/or a solvent-free silicone.

In order to improve the adhesion of the sealing system with the filling area of the composite component and to be able to subject the sealing mass to corresponding process steps, the sealing mass is preferably formed from a UV-hardening material. In particular, during the production of the roof panel, each individual layer of the sealing system is exposed to UV radiation shortly after having been applied. After the entire sealing system has been applied, i.e., all sealing mass layers, the sealing system is preferably subjected to another UV irradiation process.

In order to increase the layer thickness of the individual layers of the sealing system and to further increase the tightness of the sealing system, the sealing mass, in a preferred embodiment of the vehicle roof according to the invention, is mixed with a gas for an increase in volume. The sealing system acts as a barrier layer despite the increase in volume and prevents gas releases and the like from the composite component. The gas volume fraction of the volume of the applied material preferably amounts to 10 to 60 vol %.

The roof panel of the vehicle roof according to the invention is a removable or also fixedly mounted panel of a fixed roof or also a rigid roof shell of a convertible vehicle top which is realized as an RHT (Retractable Hard Top), which is realized as a lightweight composite component.

The invention also relates to a method for manufacturing a vehicle roof which comprises the following steps:
manufacturing a planar composite component which has at least one edge forming a filling area; and
applying a sealing mass onto the filling area, the sealing mass being applied in multiple layers for forming a multi-layer sealing system.

In order to optimize the sealing behavior of the sealing system realized in this way, in a preferred embodiment of the method according to the invention, each layer of the sealing mass, which is in particular formed from a UV-hardening material, is subjected to UV radiation for a time period of approximately 0.5 to 2.0 seconds, preferably for approximately 0.8 to 1.2 seconds, after it has been applied. This process step, which is referred to as UV pinning, has the effect that each individual layer of the sealing system reaches a state with higher viscosity and is thus solidified. Preferably, a UV LED light source is used for this.

In order to further improve the sealing behavior of the sealing system of the roof panel, it is advantageous if each layer of the sealing mass is irradiated with the UV light for approximately 0.5 to 2.0 seconds, preferably for approximately 0.8 to 1.2 seconds, after it has been applied. This means that the UV pinning of the individual layers of the sealing system is essentially carried out directly after they have been applied. Hereunto, the UV light source can form a structural unit together with the application system used for applying the sealing mass, which may be realized as a spray head or also as a dosing head.

For post curing of the system as a whole, it is advantageous if the sealing mass is subjected to UV radiation as a whole again after the multi-layer sealing system has been formed. In this hardening process, which can be carried out in a separate UV tunnel, the application of energy is preferably higher than 800 mJ/cm². In contrast, in the UV treatment of the individual layers of the sealing system, i.e., during UV pinning, the application of energy by means of the UV radiation amounts to approximately 100 to 200 mJ/cm², preferably approximately 150 mJ/cm².

The sealing mass which is used in the method according to the invention is preferably free from solvents so that the method can be interpreted to be an environmentally friendly process.

As it has already been explained above, it is advantageous for improving the sealing properties of the sealing system if the sealing mass is mixed with a gas, for example air, nitrogen, carbon dioxide and/or a noble gas, when the layers of the sealing system are being applied in order to increase the volume of the sealing mass, which in turn increases the tightness of the sealing system. The gas is preferably added with a voluntary flow rate of 0.5 m³/H to 2.2 m³/H leading to a gas volume ratio of 10 vol-% to 60 vol-% in the product.

The layers of the sealing mass are preferably applied in a spraying process or also in a dosing process. With the spraying process, the spraying angle of the nozzle used is preferably 6° to 30°.

The application process is for example carried out by means of an application system which can be actuated and displaced electronically and which has an application programming which is comparable to the programming of a 3D printer. On the basis of the application programming, the layers of the sealing system are built up so that the required total thickness of the sealing system is produced with a corresponding surface quality. In a sprayed application, the individual layers of the sealing system are produced in a flat and smooth manner in the layer thickness which is in each case desired.

This means that the multi-layer sealing system can be applied by means of an automatically working device, for example by means of a robot. It is also conceivable to guide an application device for the sealing mass manually.

The method according to the invention can in principle be applied for roof panels which have an unmachined edge forming the application surface on which the sealing system is applied. Preferably, the edge is, however, mechanically treated for improving the component geometry, for example subjected to a milling process. In order to prevent gas releases via the application surface which has then been mechanically treated, the sealing system realized in accordance with the invention is provided.

Further advantages and advantageous configurations of the subject-matter of the invention can be gathered from the description, from the drawing and from the claims.

An exemplary embodiment of a vehicle roof according to the invention is illustrated in the drawing in a schematically simplified manner and will be discussed in more detail in the following description.

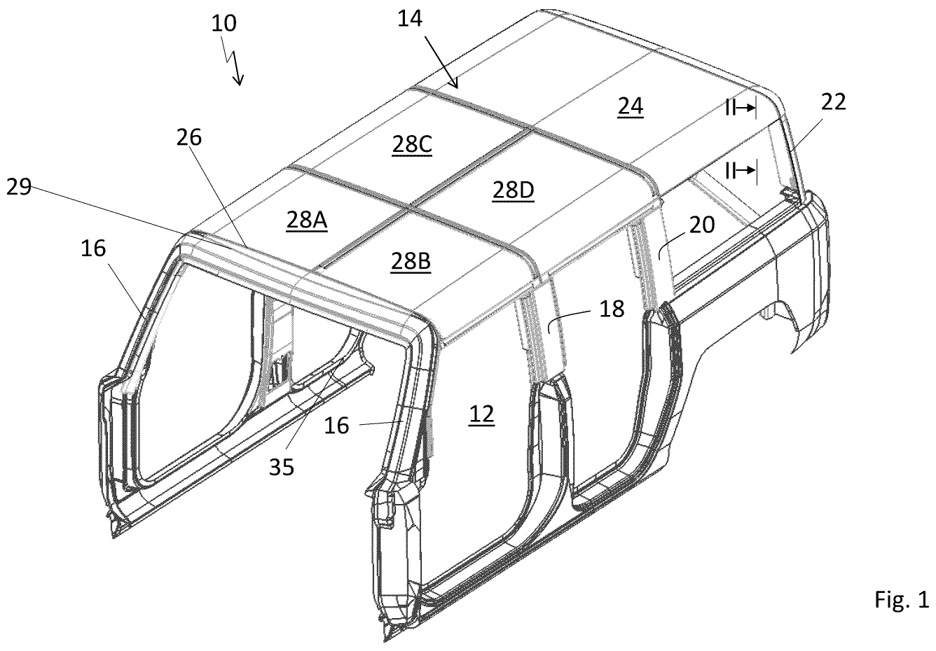

In FIG. 1, a vehicle bodywork 10 of an all-terrain vehicle is illustrated which has a vehicle interior 12 which is covered by a vehicle roof 14. The vehicle bodywork 10 has four pillars 16, 18, 20 and 22 on each side of a vertical longitudinal center plane of the vehicle, pillar 16 being an A-pillar, pillar 18 being a B-pillar, pillar 20 being a C-pillar and pillar 22 being a D-pillar. In the area between the pillars 20 and 22, the vehicle roof 14 has a fixed roof section 24 which is mounted rigidly or fixedly with respect to the vehicle bodywork 10. The vehicle roof 14 is provided with a roof opening 26 in the area between the pillars 16 and 20, said roof opening 26 being closable by four rigid roof panels 28A, 28B, 28C and 28D which can be removed individually or together.

The fixed roof section 24 and the roof panels 28A, 28B, 28C and 28D are disposed on a base structure 29 which forms a roof frame which is disposed on the pillars 16, 18, 20 and 22.

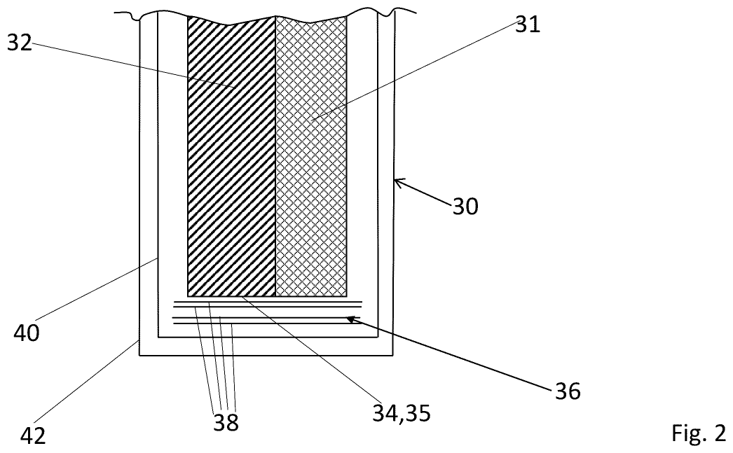

The fixed roof section 24 is formed by a roof panel 30 which constitutes a lightweight composite component which, as it can be gathered from FIG. 2, comprises a carrier layer 31 which has a honeycomb structure which is provided with a polyurethane/glass fiber mixture on both sides and which is provided with an SMC layer 32 (Sheet Molding Compound layer), which is formed from glass fiber polyester or the like. It is as a matter of course also conceivable that the composite component has another layer structure using other materials.

The composite component formed from the layers 31 and 32 has an edge 34 on each side of the vertical longitudinal center plane of the vehicle, said edges forming application surfaces 35 which are treated in a milling process and at which the structure of the carrier layer 31 and of the structural layer 32 is exposed.

For preventing gas releases, the edge 34 is provided with a sealing system 36 which is formed from a sealing mass which is disposed in multiple layers 38 one above the other and which is formed from a solvent-free polyurethane acrylate copolymer which constitutes a UV hardening material. The sealing mass of the layers 38 is mixed with a gas, for example with air, for an increase in volume.

Furthermore, the roof panel 30 is provided with a base coat 40 which reaches over the large areas of the composite component and its edge 34 including the sealing system 36 and which is in turn covered by a design lacquer 42.

The roof panels 28A, 28B, 28C and 28D can have a corresponding structure with corresponding sealing systems at the edges.

The roof panel 30 is manufactured in the manner described in the following.

In a first manufacturing step, the composite component which comprises the carrier layer 31 and the structural layer 32 is manufactured in a molding tool. This composite component has the edges 34 after having been removed from the mold. The edges 34 are subsequently subjected to a milling process so that the mechanically treated application surfaces 35 are exposed at the edges 34.

If required, a cleaning process can subsequently be carried out in a processing point.

In the following, the mechanically treated edges 34 of the composite component are provided with the sealing system 36 by means of a robot which is not illustrated in more detail and which is provided with a spray head for spraying the polyurethane acrylate on. Here, the layers 38 are individually sprayed on by means of the robot and are subjected to UV radiation within a second after having been applied for a time period of approximately one second. By way of this UV pinning process, which is carried out with an application of energy of 150 mJ/cm², the individual layers 38 move from a state with low viscosity to a state with higher viscosity and are thereby fixed. The UV radiation is applied by means of a UV LED source which is also disposed at the robot head. In the present case, four layers 38 of sealing mass are sprayed on for forming the sealing system 36 and are each fixed by the UV radiation. When it is sprayed on, the sealing mass is mixed with a gas in the spray head, in particular with air, so that the volume of the sealing mass increases.

Subsequently, the composite component is moved through a UV tunnel for hardening the sealing systems 36, the application of UV energy amounting to at least 800 mJ/cm² here.

Then, the composite component which is provided with the sealing system 36 can be conveyed to a base coating and lacquering process for forming the base coat 40 and the design lacquer 42.

### REFERENCE SIGNS

10 vehicle bodywork
12 vehicle interior
14 vehicle roof
16 pillar
18 pillar
20 pillar
22 pillar
24 fixed roof section
26 roof opening
28A, B, C, D roof panel
29 base structure
30 roof panel
31 carrier layer
32 structural layer
34 edge
35 filling area
36 sealing system
38 layer
40 base coat
42 design lacquer

1. A vehicle roof, comprising a base structure and a rigid roof panel which is fastened to the base structure and constitutes a composite component and has at least one edge forming a filling area which is sealed by a sealing system, wherein the sealing system is formed from a sealing mass applied in multiple layers.

2. The vehicle roof according to claim 1, wherein the sealing mass comprises a solvent-free acrylate, a solvent-free polyurethane, a solvent-free polyurethane acrylate copolymer and/or a solvent-free silicone.

3. The vehicle roof according to claim 1, wherein the sealing mass is formed from a UV-hardening material.

4. The vehicle roof according to any one of the claims 1 to 3, wherein the sealing mass is mixed with a gas for an increase in volume.

5. The vehicle roof according to claim 1, wherein the edge is mechanically treated.

6. A method for manufacturing a roof panel of a vehicle roof, comprising the following steps:
manufacturing a planar composite component which has at least one edge forming a filling area; and
applying a sealing mass onto the filling area, the sealing mass being applied in multiple layers for forming a multi-layer sealing system.

7. The method according to claim 6, wherein each layer of the sealing mass is irradiated with UV light for 0.5 to 2.0 seconds after it has been applied.

8. The method according to claim 6, wherein each layer of the sealing mass is irradiated with UV light for approximately 0.8 to 1.2 seconds after it has been applied.

9. The method according to claim 6, wherein the sealing mass is mixed with a gas when the layers of the sealing system are being applied in order to increase the volume of the sealing mass.

10. The method according to claim 6, wherein the layers of the sealing mass are applied in a spraying process.

11. The method according to claim 6, wherein the sealing mass is irradiated with UV radiation after the multi-layer sealing system (36) has been formed.

12. The method according to claim 6, wherein the edge is mechanically treated before the sealing mass is applied.
